(19) United States
(12) Patent Application Publication
(10) Pub. No.: US 2018/0204227 A1
(43) Pub. Date: Jul. 19, 2018

(54) Golf Pace of Play

(71) Applicants: Asheesh Rai Mohindru, Livermore, CA (US); Anish Mohindru, Laguna Woods, CA (US)

(72) Inventors: Asheesh Rai Mohindru, Livermore, CA (US); Anish Mohindru, Laguna Woods, CA (US)

(73) Assignees: Asheesh Mohindru, Livermore, CA (US); Anish Mohindru, Laguna Woods, CA (US)

(21) Appl. No.: 15/270,428

(22) Filed: Sep. 20, 2016

Related U.S. Application Data
(60) Provisional application No. 62/221,616, filed on Sep. 21, 2015.

(51) Int. Cl. G06Q 30/02

(52) U.S. Cl. CPC G06Q 30/0202

(57) ABSTRACT

The present invention teaches system, processes, and computer-engineered devices for solving and alleviating the problem of golf pace of play. It utilizes real time as well as historical data to help Golfers make sensible choices on where and when to start their play, with real time and predicted data analysis. It also helps the golf course management team to direct players and perform other course-related tasks efficiently. The invention would have a significant impact on the golfing industry, especially on Golfers' performance and daily lives.

### RELATED APPLICATION

This application claims priority under 35 U.S.C. $119(e) of the U.S. provisional application Ser. No. 62/221,616, filed on Sep. 22, 2015, and titled “Golf Pace of Play”, which is hereby incorporated in whole by reference.

### TECHNICAL FIELD

This invention pertains to monitoring and predicting the speed of play at a golf course. In particular, this invention relates to a system and a method for obtaining various data and predicting the speed of a golf course based on that data.

### BACKGROUND

The present invention is directed to a chronic problem in the game of golf that is often referred to as Golf Pace of Place (GPOP). This is a problem that potentially affects approximately 25 million amateur golfers in the USA. The scope of this problem is orders of magnitude in the global setting. It is generally accepted that an ideal round of 18 holes of golf (par 72, nine on the front, nine on the back) should be completed in a reasonable amount of time, which has been estimated at about 4 hours by a group of 4 players. The average time spent playing each hole in this ideal round should be 13.3 minutes. This is an ideal state, and, regrettably, this GPOP, a 4-hour round, is far from typical. The 4-hour GPOP is mostly experienced by country club members, who enjoy wealth-based privilege, or this ideal GPOP may also be occasionally experienced by golfers who start play during the early part of the day, and in doing so, have access to a “vacant” golf course. For the rest of the community of golfers, who are not members of golf clubs, and who are unable to play at daybreak, for this majority golfing segment, rounds of over 6 hours are not uncommon, particularly in courses operated publicly by municipalities. This is the community of millions who are underserved and for whom this invention is a solution. Hence, this invention addresses an unmet need for solutions to the problem of golf GPOP.

GPOP has several negative effects on the golfer and his or her GPOP. The slow pace results in what is referred to as the loss of rhythm. Essentially, the golfer's in-play muscles and joints become hyper-reflexive and the ability to smoothly swing the golf club is impaired. This can have an impact on the entire game, especially if the Golfer is playing a tournament or is in a league. Secondly, the Golfer will suffer loss of mental focus, as he or she idly watches the forward Golfers, who are either also stalled or moving very slowly. Focus is recognized as a key factor in superior golf play. Professional Golfers pay particular attention to this aspect of the game. When combined, the idle intermission between golf shots results in a poor performance.

In addition to on-course adverse effects experienced by the golfer, there are collateral effects in the golfer's lifestyle. Every fraction of the hour “wasted” due to slow GPOP, the affected party loses equal and (perceived greater amount of) time with human interaction, which includes time spent with family, friends, or other leisure, work-related activities. This is not trivial when you do the math with the 25 million number.

Despite these adverse effects there is currently no accurate way to predict the amount of time it would take a user to play a golf course, or to optimize the golf course to reduce the pace of play.

### SUMMARY OF INVENTION

The present invention discloses novel systems, and processes for monitoring the GPOP on a golf course, obtaining variables that affect the speed of play, and predicting the amount of time it would take a golfer to play one or more holes within a golf course. In one embodiment, the system monitors current GPOP based on user input or GPS data obtained from a user's device. The system also obtains speed factor data such as the number of players on the golf course at the time of play, the handicap of the players on the golf course, the pace of play of each player on the golf course, the level of difficulty of the golf course, the weather conditions at the golf course at the time of play, the day of the week, the time of play, and the number of golfers in a group such as two-somes, three-somes, or four-somes. The systems predicts the amount of time it would take a golfer to play one or more holes within a golf course based on the obtained GPOP and the speed factor data. The systems and methods disclosed herein help golfers make informed selections and choices on where and when to start their play, and provides them with a prediction on the amount of time it would take them to play a particular golf course.

### BRIEF DESCRIPTION OF THE DRAWINGS

FIG. 1 is a high level diagram illustrating the components for monitoring the GPOP of a golf course, predicting the amount of time it would take to play one or more holes within a golf course, and displaying the predicted data to a user or a golf course manager.

FIG. 2 is a high level block diagram of the various components of the system. It shows the system network includes at least three different systems, i.e. monitoring system, geogagging system, and prediction system, and two separate devices, used by on-site golfers and users, respectively. A database containing speed factor variables is part of the system.

FIG. 3 is a high-level block diagram on the hardware that may present in a user device 105, a golfers' device 100, a prediction system 110, or a monitoring system 160 according to one embodiment.

FIG. 4 shows the schematic workflow of one of the embodiments of the instant invention, wherein the pace of play is predicted based on the golfers' real-time play data, user input and speed factors variables.

FIG. 5 lists sample variables that the instant invention incorporates into the speed factors database.

FIG. 6 lists different algorithms and logics the instant invention may use to predict pace of play.

### DETAILED DESCRIPTION OF THE INVENTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

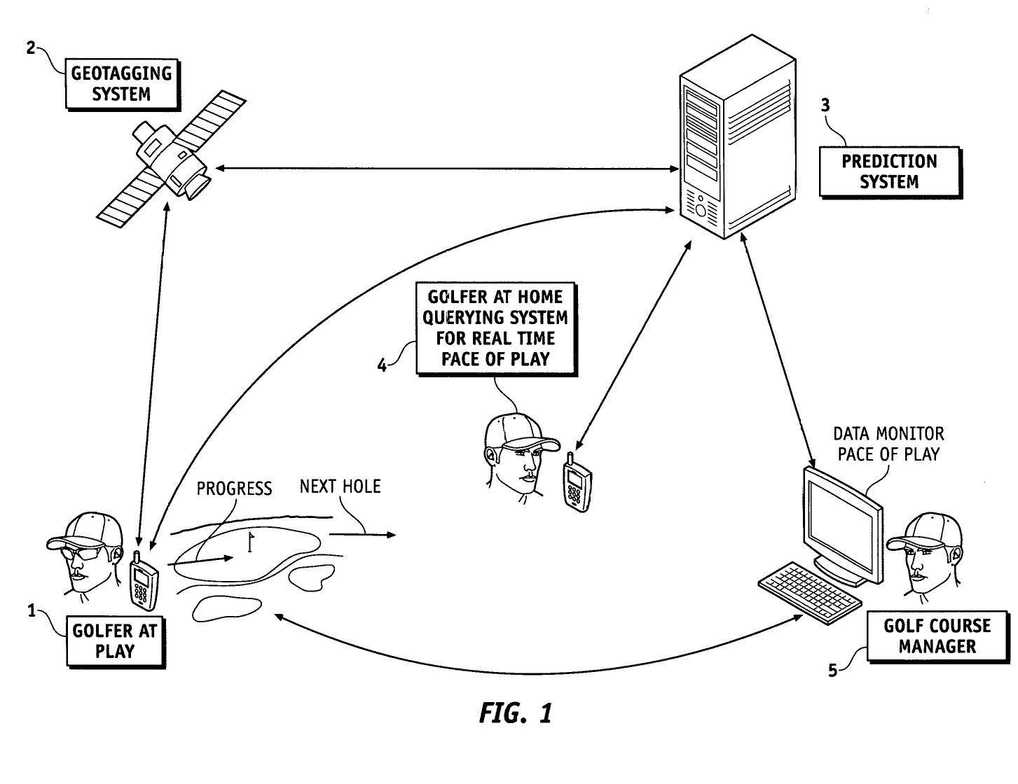

FIG. 1 is a high-level diagram illustrating the components for monitoring the GPOP of a golf course, predicting the amount of time it would take to play one or more holes within a golf course, and displaying the predicted data to a user or a golf course manager.

As illustrated in FIG. 1, the instant invention may involve several inter-related components, including (1) a golfer at play on a golf course, (2) a geotagging system for tracking the location of a golfer within the golf course, (3) a prediction system that predicts the amount of time it would take a golfer to play one or more holes within the golf course, (4) one or more users who query the prediction system to learn the amount of time it would take to play one or more holes within a golf course, and (5) one or more golf course managers who monitor the GPOP associated with one or more golf courses, and the predictions from prediction system.

When a golfer starts to play on a golf course, his or her location and time data is captured by the geotagging system (2), then sent to prediction system (3). Another alternative is the golfer's play data is sent to the prediction system (3) directly from golfer's device. Prediction system (3) also receives user's input, such as those text and numerical input from user's smart phone, cell phone, smart watch, computer, etc. Data generated by prediction system (3) is feed back to the golfer-at-play, the user and the golf course manager.

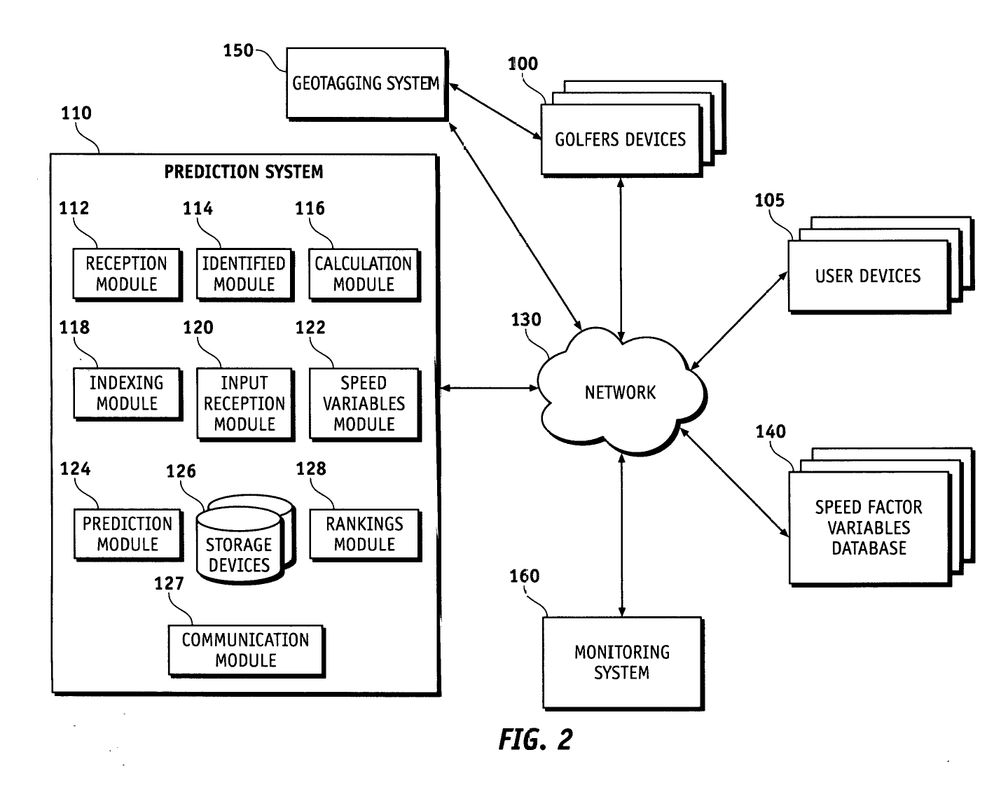

FIG. 2 is a high level block diagram of the various components of the system. It includes monitoring system, geogagging system, and prediction system, and two separate devices, used by on-site golfers and user, respectively. A database for the speed factor variables 140 is part of the system. The network 130 enables communications between the user devices 105, golfers devices 100, geotagging system 150, speed factor variables database 140, monitoring system 160, and prediction system 110. In one embodiment, the network 130 uses standard communications technologies and/or protocols, and may comprise the Internet. Thus, the network 130 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 130 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 130 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

The golfers' device 100, and user devices 105 are electronic devices used by users or golfers to transmit data to the prediction system 110 via the network 130. In one aspect, each of the user devices 105 and golfers' devices may be a suitable computing device. For example, an individual user device 105 or a golfer's device may be a desktop computer system, laptop, workstation, or server. An individual user device 105 or a golfer's device may also be a mobile computing device, such as a smartphone, tablet device, portable gaming device, e-reading device, personal digital assistant (PDA), etc. In one aspect, the user devices 105 or the golfers' devices each execute a suitable operating system, such as Android, Apple iOS, a Microsoft Windows-compatible operating system, Apple OS X, UNIX, and/or a Linux distribution. The user device 105 and the golfer's device may further execute suitable software applications, such as a web browser (e.g., Google Chrome, Microsoft Internet Explorer, Apple Safari, Mozilla Firefox, etc.), a native application (e.g., Microsoft Word for the Windows Operating System), etc. The geotagging system 150 tracks golfers' location within a golf course. The geotagging system suitable for the instant invention includes GPS systems, RFID systems, WiFi location tracking systems and any other similar systems.

The golfers' devices 100 transmit a variety of data to the prediction system 110 via the network 130. The data transmitted from golfer's device include both text and numerical data, which provides information on the location, the time, the hole number, the par data and other relevant play data.

The user devices 105 also transmit a variety of data to the prediction system 110. The data transmitted from user's device include both text and numerical data, which provides all the information that a user may request, such as time of play, the amount of time the user would like to spend playing, the amount of money he/she wants to spend, the geographic distance he want to travel, etc.

The speed factor variables databases 140 contain factors that affect the pace of play. These factors include, but not limited to, number of players on the golf course, the number of players in each group, the handicap of the players, such as USGA handicap index, the pace of play of each player, and golf course's physical conditions, such as the type of golf course (sandy or hard soil), the level of difficulty of the course, the temperature, humidity, wind speed, wind direction at the course. The factors may also include week of the day and time of the day.

The prediction system 110 predicts the amount of time it would take a user to play one or more golf courses based on the users' input. The prediction system 110 involves multiple modules.

The reception module 112 is for obtaining data from one or more golfers who are playing on a golf course, wherein the obtained data enables the calculation of the amount of time it took the golfers to complete one or more holes within a golf course;

The identification module 114 is to identify the golf course that each golfer is playing. Once identified, this particular golf course's physical data, such as geolocation, its type, difficulty play is also associated by the identification module. The calculation module 116 is for calculating, for each identified golf course, the amount of time it takes the golfers to complete one or more holes within a golf course. The indexing module 118 is to associate the calculated amount of time for each golfer with the identified golf course and speed factor data, wherein the speed factor data affects the pace of play. The input reception module 120 is for receiving a user input, both text and numerical data input, such as the selection of one or more golf courses or the location of one or more golf courses for play, the amount of time of the user would like to play, the fees user is willing to pay, and how far user is willing to travel. The speed variable module 122 is for obtaining speed factor variables for each golf course selected by the user, wherein speed factor variables affect the pace of play. The prediction module 124 is to predict the pace of play for each golf course selected based on the amount of time it takes one or more golfers to complete one or more holes within a golf course based on the available speed factor data, and the obtained speed factor variables. The communication module 127 is to provide the predicted data to the user. Ranking module 128 is for ranking golf courses based on their predicted pace of play and the user input, wherein the user input identifying one or more of the following: the amount of time a user would like to play one or more holes within a golf course; the amount of money the user would like to spend on fees; and the speed with which the user would like to play.

In one embodiment, the GPOP data may be stored in different storage devices 126. In one aspect, the data may be stored in a manner that enables a high level of data recoverability and accessibility. For example, the data may be stored in storage devices 126 situated in different network racks, in different buildings, in different data centers, etc. Thus, an incident affecting one piece of data, such as a loss of power to a particular network rack, is unlikely to also affect accessibility of the pieces of data. In one aspect, the storage devices 126 are operated as a single logical entity despite being separate physical devices. The storage devices 126 may be located in the same network racks, in different network racks located in the same geographic location (e.g., within the same building or data center), and/or located across different geographic locations (e.g., within various buildings or data centers located in different cities or countries). The storage devices 126 may additionally be interconnected in any suitable manner, such as over a backplane connection, over a suitable network connection, etc.

In one aspect, each of the storage devices 126 is a suitable storage device, such as a magnetic-based hard drive, a flash-based storage device (e.g., a NAND based solid state hard drive), an optical storage device, a storage device based on random access memory, and/or the like. In one embodiment, the storage devices 126 are each the same type of storage device and have similar device characteristics. In another embodiment, the storage devices 126 are diverse storage devices having varying device characteristics (e.g., different bandwidths, etc.).

The monitoring system 160 monitors the GPOP of a golf course and the predicted amount of time it would take to play one or more holes within the golf course. The monitoring system enables continuous real-time monitoring of each player's performance on a particular golf course.

System Architecture

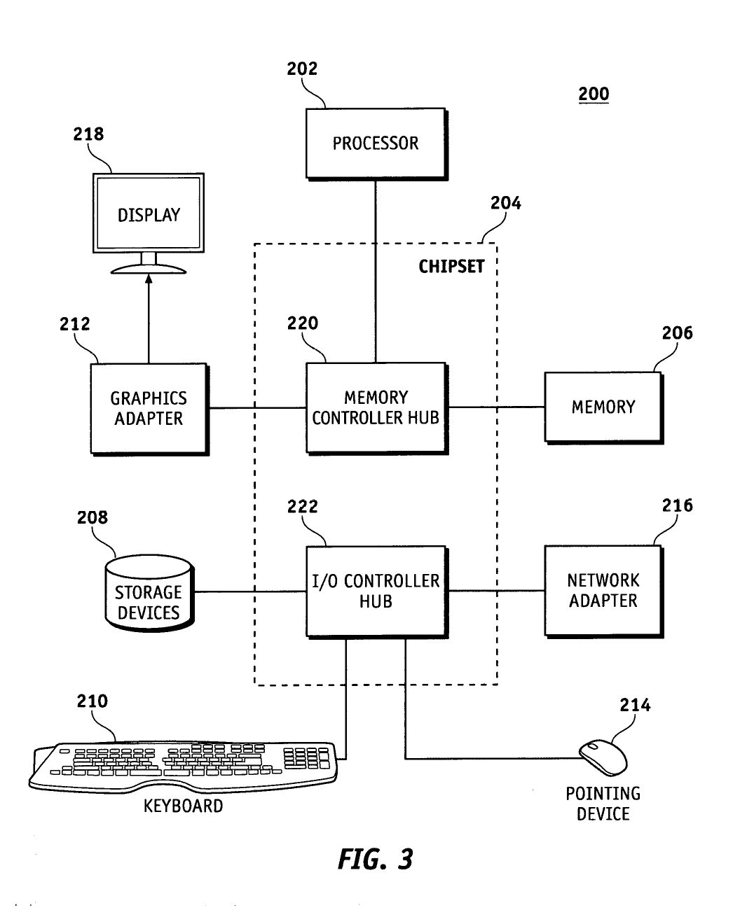

FIG. 3 is a high-level block diagram on the hardware that may present in a user device 105, a golfers' device 100, a prediction system 110, or a monitoring system 160 according to one embodiment. The computing system 200 may be a smartphone, tablet device, portable gaming device, e-reading device, personal digital assistant (PDA), or a server. The specific components may vary, but the general processing capabilities of the devices are illustrated in FIG. 3. Specifically, the figure illustrate at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of to the chipset 204. The storage device 208 is a non-transitory computer-readable storage medium, such as a hard drive, compact disk read-only memory (CD-ROM), DVD, or a solid-state memory device. The memory 206 holds instructions and data used by the processor 202. The pointing device 214 may be a mouse, track ball, or other type of pointing device, and is used in combination with the keyboard 210 to input data into the computer system 200. In some embodiments, the input devices may include touch or stylus input and may not include a pointing device or a keyboard. The graphics adapter 212 displays images and other information on the display 218. The network adapter 216 couples the computer system 200 to the network 130.

As is known in the art, a computing device 200 can have different and/or other components than those shown in FIG. 2. In addition, the computing device 200 can lack certain illustrated components. In one embodiment, a computing device 200 acting as the prediction system 110 is formed of multiple spatially and/or time distributed blade computers and lacks a keyboard 210, pointing device 214, graphics adapter 212, and/or display 218. Moreover, the storage device 208 can be local and/or remote from the computer 200 (such as embodied within a storage area network (SAN)).

As is known in the art, the computing device 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Processing Overview

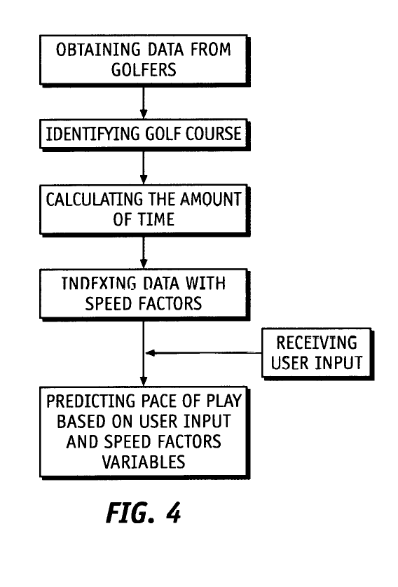

FIG. 4 shows the schematic workflow of one of the embodiments of the instant invention, wherein the pace of play is predicted based on the golfers' real-time play data, user input and speed factors variables. Particularly, the first step is the obtain the play data from each of on-site playing golfers through golfer's device or geotagging system, then the golf course is identified. Thirdly, the prediction system calculates the amount of time each golfer took to finish a hole or several holes. Fourthly, system indexes data with speed factors. When user provides input and is received by the system, the system can predict pace of play based on user input and speed factors variables.

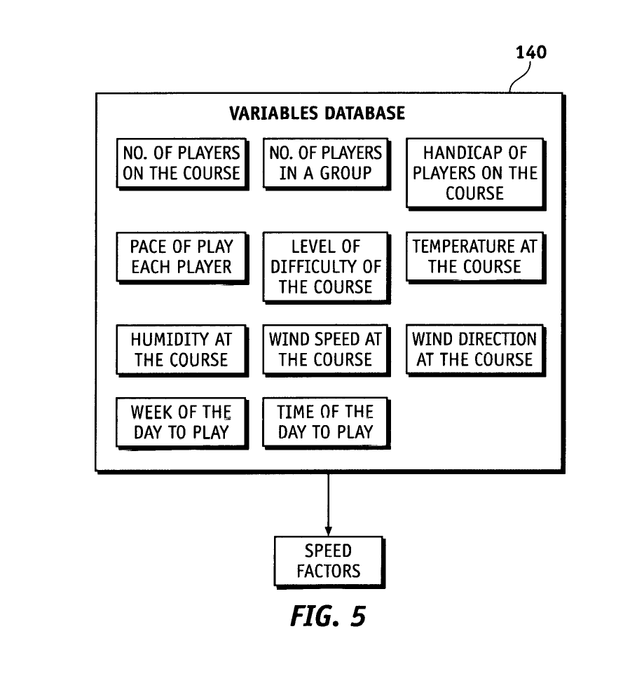

FIG. 5 lists sample variables that the instant invention incorporates into the speed factors database. These variables includes, but not limited to, number of players on the golf course, the number of players in each group, the handicap of the players, such as USGA handicap index, the pace of play of each player, and golf course's physical conditions, such as the type of golf course (sandy or hard soil), the level of difficulty of the course, the temperature, humidity, wind speed, wind direction at the course.

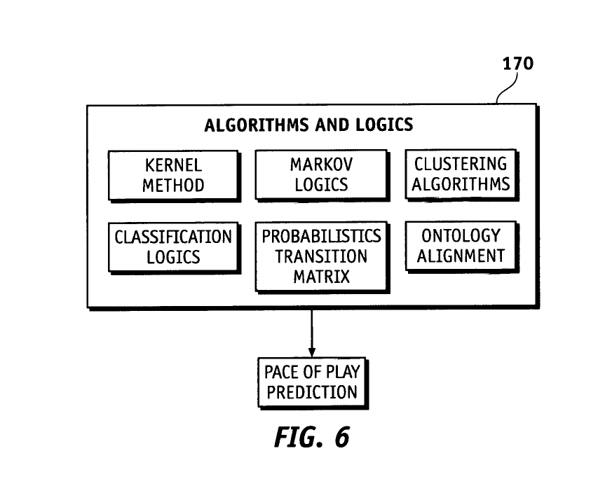

FIG. 6 lists different algorithms and logics the instant invention uses to predict pace of play. Multiple algorithms and machine operations may be deployed to predict the pace of play and speed factors. In one embodiment kernel methods are used to obtain non-linear values for pace velocity in real time and across multiple hole-to-hole intervals. Other methods used are Markov logic networks to for forecasting pace velocity at a plurality of golf locations. With increased data aggregation, clustering and classification algorithms are used to process large data sets, establish clusters, and create ontologies. In other embodiments golf navigation and pace velocity are subjected to a probabilistic transition matrix, allowing the use of documented formulas. The validity of prediction models is achieved with empirical evaluation of generated data at fixed time intervals.

In the instant invention, different algorithms and logics are desired and used against the real time play data and the speed factor variables to give an accurate and reliable estimate and prediction on the pace of play. It is well observed that the dynamic of a golf course depends not only on human play factors, such as player's skill level, which can be somewhat reflexed by his or her Handicap Index (such as USGA Index), but also depend on a lot of uncontrollable physical factors, such as the difficulty of the course and weather conditions. The instant invention applies different algorithms to different factors. For example, at a particular course, different players' real time play data are treated with Markov logic to obtain the relational pattern wherein each golfer's Handicap Index can be more reasonably correlated with the difficulty of this golf course, thus the prediction for the future play on this particular course can be more reliably predicted through this site generated Markov relational pattern. As for weather factors, such as wind speed, kernel method is used, wherein a non-linear progression approach is performed. That is a first prediction is made based on a previous real-time play data and the wind speed at that moment, then recalibrate the prediction based on the real real-time play data. This kernel recalibration and regression treatment can be repeated as many times as possible until a reliable prediction is obtained in relationship to wind speed. Another example is temperature and humidity. Since most golf courses keep good records of their courses' temperature and humidity, the use of averaged data, i.e. averaged day temperature and humidity vs that day's average pace of play can be a convenient approach. To make sure this convenience can yield reasonable good prediction, clustering approach or cluster analysis may be applied, wherein sets of explorative and exemplary data can be clustered and analyzed to find the general pattern on how temperature and humidity generically alter the pace of play in an averaged sense, and predict the average pace of play for a future day. After the aforementioned speed variable factors are treated individually against pace of play, a final probabilistic transition matrix is applied, and thus produce a series of predicted place of play time with their probability of occurring. User can choose to see the most probable pace of play time, or see all the pace of play time with their probability. The processing steps and methods described above is by the way of illustration only. One skilled in the art will readily recognize from the description that alternative algorithms and methods may be employed without departing from the principles described herein. It is noted that wherever practicable similar or like algorithms may be used to accomplish the same task.

In one embodiment, the invention discloses a method for calculating pace of play of golf courses, comprising the steps of
a. obtaining data from one or more golfers who are playing on a golf course, wherein the obtained data enables the calculation of the amount of time it took the golfers to complete one or more holes within a golf course;
b. identifying the golf course that each golfer is playing;
c. calculating, for each identified golf course, the amount of time it took the golfers to complete one or more holes within a golf course;
d. associating the calculated amount of time for each golfer with the identified golf course and speed factor data, wherein the speed factor data affects the pace of play;
e. receiving a user (i.e. an off-site golfer) input such as the selection of one or more golf courses or the location of one or more golf courses for play;
f. obtaining speed factor variables for each golf course selected by the user, wherein speed factor variables affect the pace of play;
g. predicting the pace of play for each golf course selected based on the amount of time it took one or more golfers to complete one or more holes within a golf course based on the available speed factor data, and the obtained speed factor variables; and
h. providing the predicted data to the user.

Further, it discloses the method wherein predicting and simulating the pace of play for each golf course comprises making the predictions and simulations in real-time based on current speed factor variables. Further, the data obtained from one or more golfers comprises Global Positioning System (GPS) location and time data from each golfer or location and time data from other geotagging system, such as RFID systems, WiFi location tracking systems, etc.

Further, the data obtained from one or more golfers comprises data input by the on-site playing golfers, wherein the input data identifying their location within a golf course, or the amount of time it took the golfer to complete one or more holes within a golf course.

Further, the speed factor data comprises one or more of the following: the number of players on the golf course at the time of play, the handicap of the players on the golf course, the pace of play of each player on the golf course, the level of difficulty of the golf course, the weather conditions at the golf course at the time of play, the day of the week, the time of play, and the number of golfers in a group such as two-somes, three-somes, or four-somes.

Further, the user input comprises one or more golf courses for play or a geographic area for play.

Further, the user input further comprises a desired date and time for future play.

Further, the user input comprises an inquiry for current pace of play based on real-time data at one or more selected golf courses.

Further, the user input comprises the amount of time a user would like to play.

Further, the speed factor variables may be obtained from a variety of sources, including one or more of the following: the golf course's database or directory, a weather service, an database of player's handicap index, and a database of pace of play associated with each player.

Further, the data obtained from a golf course's database or directory comprises one or more of the following data: the number of players scheduled to play at a desired day and time of play, and the number of players that historically play at the desired day and time of play.

Further, the speed factor variables comprise one or more of the following: the number of players on the golf course at a desired time of play, the handicap of the players on the golf course at a desired time of play, the pace of play of each player on the golf course who are scheduled to play at a desired time of play, the level of difficulty of the golf course, the weather conditions at the golf course at the desired time of play, the desired day and time of play, and the number of golfers in a group such as two-somes, three-somes, or four-somes.

The method of the instant invention further comprises of ranking golf courses based on their predicted pace of play and the user input, wherein the user input identifying one or more of the following: the amount of time a user would like to play one or more holes within a golf course; the amount of money the user would like to spend on fees; the speed with which the user would like to play.

The instant invention also discloses a system, such as the one showed in FIG. 2 for calculating pace of play of golf courses, comprising:
a. A reception module for obtaining data from one or more golfers who are playing on a golf course, wherein the obtained data enables the calculation of the amount of time it took the golfers to complete one or more holes within a golf course;
b. a golf course identification module for identifying the golf course that each golfer is playing;
c. a time calculation module for calculating, for each identified golf course, the amount of time it took the golfers to complete one or more holes within a golf course;
d. an indexing module for associating the calculated amount of time for each golfer with the identified golf course and speed factor data, wherein the speed factor data affects the pace of play;
e. an input reception module for receiving a user input selecting one or more golf courses or the location of one or more golf courses for play;
f. a speed variable module for obtaining speed factor variables for each golf course selected by the user, wherein speed factor variables affect the pace of play;
g. a prediction module for predicting the pace of play for each golf course selected based on the amount of time it took one or more golfers to complete one or more holes within a golf course based on the available speed factor data, and the obtained speed factor variables; and
h. a communication module for providing the predicted data to the user.

Further, the prediction module of the system is capable of predicting the pace of play for each golf course comprises making the predictions in real-time based on current speed factor variables.

Further, the reception module of the system receives GPS location and time data from each golfer or location and time data from other geotagging system.

Further, the reception module obtains input by the on-site playing golfers, wherein the input identifies the location of the golfers within a golf course, or the amount of time it took the golfer to complete one or more holes within a golf course.

Further, the indexing module of the system associates obtained data with speed factor data, which comprises one or more of the following: the number of players on the golf course at the time of play, the handicap of the players on the golf course, the pace of play of each player on the golf course, the level of difficulty of the golf course, the weather conditions at the golf course at the time of play, the day of the week, the time of play, and the number of golfers in a group such as two-somes, three-somes, or four-somes.

Further, the input reception module of the system receives one or more golf courses for play or a geographic area for play.

Further, the input reception module receives a desired date and time for future play.

Further, the input reception module receives an inquiry for current place of play based on real-time data at one or more selected golf courses.

Further, the input reception module receives input comprising the amount of time a user would like to play.

Further, the speed variables module obtains variable from a variety of sources including one or more of the following: the golf course's database or directory, a weather service, an database of player's handicaps, and a database of pace of play associated with each player.

Further, the speed variables module obtains one or more of the following data from a golf course's database or directory: the number of players scheduled to play at a desired day and time of play, and the number of players that historically play at the desired day and time of play.

Further, the speed factor variables obtained by the speed variable module comprise one or more of the following: the number of players on the golf course at a desired time of play, the handicap of the players on the golf course at a desired time of play, the pace of play of each player on the golf course who are scheduled to play at a desired time of play, the level of difficulty of the golf course, the weather conditions at the golf course at the desired time of play, the desired day and time of play, and the number of golfers in a group such as two-somes, three-somes, or four-somes.

Further, the system of the instant invention further comprises of a ranking module for ranking golf courses based on their predicted pace of play and the user input, wherein the user input identifying one or more of the following: the amount of time a user would like to play one or more holes within a golf course; the amount of money the user would like to spend on fees; the speed with which the user would like to play.

Multiple algorithms and machine operations are deployed to predict the pace of play and speed factors. In one embodiment kernel methods are used to obtain non-linear values for pace velocity in real time and across multiple hole-to-hole intervals. Other methods used are Markov logic networks to for forecasting pace velocity at a plurality of golf locations. With increased data aggregation, Clustering and Classification algorithms are used to process large data sets, establish clusters, and create ontologies. In other embodiments golf navigation and pace velocity are subjected to a probabilistic transition matrix, allowing the use of documented formulas. The validity of prediction models is achieved with empirical evaluation of generated data at fixed time intervals.

Our invention is described in general terms to allow the reader to understand the underlying principles, ideation, and problem solving. However, the description submitted in this non-provisional application, including submitted drawing and other supporting documents, should not be interpreted as the entire scope, breadth, depth, or evolution of the problems, ideas, solutions, and descriptions captured in this document. Alternative practices or procedures utilizing the same principles and ideation are also covered in the invention disclosed herein.

The present invention comprises of three essential physical components with data transfer among them. The data transfer includes, but is not limited to, data transfer from one physical component to the others; data re-calibration before transferring to the other two components; real time and simulated data access, retrieval and delivery; and data storing and archiving.

Specifically, the three essential physical components are:
1. A prediction system capable of constantly and continuously receiving and recording location and time data of a plurality of golfing subjects on a plurality of geographical locations. Particularly, in this invention, the prediction system is capable of recording, tracking and storing the temporal and directional progress of a plurality of golfers, on multiple golf courses, and with no limits on the time or volume of the amount of golfers monitored. For example, a GPS or other geotagging system may be adapted for this purpose. This GPS is linked to other systems that are connected to geo-orbiting satellites, and are capable of tracking a subject precisely as to location, time and movement, and with respect to coordinates that precisely match the geography of the golf course. The prediction system can compute, calibrate and simulate GPOP time for each Golfer, from hole to hole, and for the duration of the entire round of play, and furthermore aggregating this information for all golfers on the course, archiving this information in relational databases, and computing the average GPOP for each golf course in real time, as well as averaging this time with all others that are recorded in the database, providing both a real time simulation of the GPOP for a particular course, being played at a particular time, and reflecting the actual number of golfers on the course at the exact moment that the application is computationally queried fort this information. Further, the prediction system can re-calibrate the real-time data against physical factors, such as difficulty of the course, season and weather conditions, such as temperature, wind and humidity. The re-calibrated data are also fed into the relational databases. Moreover, while the prediction system constantly and continuously receives data from the geotagging system, it continuously monitors and captures each individual hole's real-time play data, and calculates a play speed factor based on par value of the hole (say Par 3, Par 4 or Par 5). These data provide insights for the golf course managers to identify potential bottleneck holes.
2. A data input interface that can receive data input from the user (the remote golfer), and has the function of allowing user registration, so that each and every data point recorded in the prediction system has a unique ID to identify itself. Another example of the function of the interface is to open up a menu for the user to query the above described data center for information related to the golf course the user has selected from the menu, and the user (Golfer) is served information that is relevant to his forthcoming plans to play the same golf course. The data input interface can serve information includes, but is not limited to,
   a. The location of the legitimate owner of the interface, if the location is not already incorporated in the application registration process and form, information that is used for all downstream user-initiated querying, as well as the data collection described above
   b. Information that addresses if the golf course at THAT MOMENT playing slow, medium, or fast
   c. Furthermore, are there any simulation or forecasts for GPOP for later in the day, or any number of future days, that are either better or worse than the real time data for the time that the Golfer queried the database
   d. The number of Golfers that are present on any desired hole, allowing the querying Golfer to determine where the bottlenecks are present—reasons for the GPOP to be less than optimal (13.3 minutes average per hole).
   e. A dashboard that compares the above data, statistics, forecasts, with other courses of similar rating (green fees, level of difficulty, travel distance from Golfer's place of departure)
   f. the Golfer's past golfing history and have available information that might be useful in determining future plans for golfing destinations that are primarily dependent on achieving a GPOP that matched the optimum levels described earlier in the introduction.

The data input interface can also have utility for the golf course managers. This utility relies on data as described above, but may contain additional information as appropriate to commerce, as permitted under prevailing laws. For example, this utility, which may be operable on non-hand-held devices, allows the golf course management team to view business-critical data for optimizing traffic on the course, which again depends on GPOP. For example, the invention permits the operator to determine holes that are causing GPOP slow down. The system also allows the operator to determine if there are individuals or groups of individuals that may be linked to GPOP slow down.
3. A data display interface that can display data retrieved from the prediction system and calculated based on the user (golfer) input through data input interface. The interface can display data in either numerical or graphical format, or both.

The invention can implement various functions to help golfers navigating away from slow GPOP and golf course management to better manage GPOP. Three exemplary examples are described in detail below. First of all, the invented system can be used by an individual golfer to select and decide which golf course to play on a particular date and time, through a simple step of opening a “Where to Play” menu displayed on the data input interface, such as their phone or computer, wherein the golfer can choose one or more selection criteria and give the preferred values. The criteria can include items such as the distance to the golf course, the difficulty of play, the type of golf course, fee charged for golf play, the time range of the Golf Pace of Play (GPOP), the preferred date and time of golf play, and the weather condition. The values input by the golfer are then transmitted to the prediction system capable of storing, receiving, retrieving and transmitting data and operable through a data processing mechanism. The data managed by this system comprise of
(1) stored pre-existing data, including, but not limited to,
   This individual golfer's profile, such as gender, age, level of golf playing skills (golf handicap), past play record, and current or resident location;
   Profiles of various golf courses, such as their geographical locations, the courses' types, the difficulty of play, and the fee to play, Golf Pace of Play values captured in the past, and weather data;
(2) received real time data input, including, but not limited to,
   Data input by the golfer through the selection menu, the data can be specific number, number range and text/character values;
   The real-time Golf Pace of Play data from on-site golfers in various golf courses, such as geographical data of the hole, time data of the play, shot data, length of putt data, penalty data, and a score and distance data obtained by measuring a position of a shot or a putt.

The invention will now be explained with reference to a number of non-limiting examples.

### Examples

### Example 1. A Golfer Goes to the Course and Starts Round, and the Prediction System Starts to Collect Data

In this example, a Golfer is ready to play golf. The Golfer arrives at the golf course and takes steps to register through the data input interface into the Prediction System. Included in this process is checking in at the Golf Pro shop, confirming the tee time (the time when the Golfer will start the round on the first or other designated hole), paying for the golf round fees, optionally obtaining an electric golf cart, checking on the contents in the golf bag, and putting on golf shoes. When announced, the Golfer, accompanied by three others in the foursome, arrives at the starting tee, which is generally the first tee, but may also be the tenth tee.

Once the Golfer is nearing the tee time, the Prediction System starts by identifying the Golfer and the golf course. The former is achieved by the prior registration process by the Golfer. The latter is achieved with GPS technology. The Golfer presses a START button to initiate the data recording and gathering by the Data Center, which will measure the GPOP at all points in the golf round. The information gathered in these routines will include the time interval between the starting hole and the next one, the time interval between the second hole and the third hole, and so on until the Golfer arrives at the end of the round. The prediction system will stop the data recording automatically and gathering when the Golfer exits the last hole, typically after 18 holes.

Throughout the golf round, GPOP data, the hole play speed factor, and other relevant data, such as difficulty of course, season and weather data, including but not limited to temperature, wind and humidity data, are constantly and continuously collected, recorded and processed by the Prediction system. Further, the Prediction system can use the gathered data to re-calibrate the real-time data, and use them to average GPOP for the golf course and simulate GPOP data in a future point.

### Example 2. A Golfer at Home (Hereafter User) Tries to Decide where and when to Play Golf

In this example, a golfer is preparing to play golf, and needs to make a decision as to where and when to play. The Golfer has the data input interface properly installed. The Golfer starts the interface and views a menu that has the multiple options. These options include, but not limited to, the following:
1. An option to view golf courses in the area, as defined by a radial distance, e.g. a 15-mile radius
2. An option to view golf courses based on the GPOP, as recorded in the Data Center, which aggregates data and compute average GPOP numbers
3. Other options that allow the Golfer to rank lists with the shortest GPOP cross-ranked with green fees (the fee charged by the golf course operator in exchange for a round of golf.
4. An option whereby for a specific course, the Golfer can view a tending graph that shows the longest and shortest GPOP times during a single day or during a single week.

The Golfer at home uses the data input interface to input preferred values for multiple golf course-selection criteria, to make a decision on where he or she should play, based on the information provided by the system. For example, The Golfer
Can determine which course is closest but has GPOP less than 5 hours.
Opt to find a course that costs more but has a GPOP less than 4 hours.
May choose to play the next day, when both the cost and GPOP are more favorable than the comparable values for the current day.

Once the Golfer goes the golf course and plays a round of golf, the Prediction system records the Golfer's real time GPOP, capture the data, and associate it with the Golf Course. In this manner, the Golfer will have an aggregate record of past paces of play, which can be benchmarked with the Golf Course's average GPOP for specific time periods.

### Sub-Example 2a

Using the disclosed invention, the Golfer at home can make informed selection and decision on where and when to play, can input geo-tagging meta-data, such as the zip code where he is located, make selections regarding community or private golf courses, specify the desired start times, specify the desired round-completion time, and other information, such as the difficulty slope, presence of water hazards, length of the course, and a price range for cost of play (“green fees”).

### Sub-Example 2b

Similar to the example above, the Golfer at home can use the instant invention to make similar decisions and obtain relevant information to allow for an upcoming golf outing (not in the present, but in the future). This functionality is possible by the disclosed prediction system, wherein pertinent data are archived, processed, and predicted.

### Example 3. Golf Course Manager Uses the Instant Invention to Better Manage GPOP

This invention also provides the Golf Course Management team with a tool for better real time management of the GPOP. The Golf Course Management team is seated in front of a computer or has a hand-held device. The computer or the device has a specialized data input interface. This interface presents the Golf Course Manager with all the data that is received by the prediction system. The Golf Course Manager, using the instant invention has
1. Real time data on the number of golfers actively playing on their golf course,
2. Accurate readings on the time spent for each hole, by each golfer, by each foursome, and for an aggregate 18-hole round;
3. Real time data on the hole play speed factor, which is calculated based on par value of the hole;
4. Real-time re-calibrated data, wherein the hole play speed factor is re-calibrated against physical factors, such as difficulty of course, season and weather factors, such as temperature, wind speed and direction, and humidity;
5. A dashboard that flags Golfers that are significantly below the average GPOP;
6. Other data maps that compute the expected GPOP with remaining golfers who have not teed off, but have reservations.

These data, dashboards, digital visualization heat maps, and other outputs allow the Golf Course Manager to make rational decisions on how to “move the traffic” on the Golf Course to improve the GPOP.

### Example 4. The Invention Helps a Golfer to Monitor his or her Own Performance

Since the instant invention is designed for use on the golf course, it allow the golfer to input scores and other performance data, such as length of drives, greens-in-regulation, and putts made. These data will be golf-course-centric, and allow the golfer to directly compare data points, as well as computed indexes, such “how well did I play” amongst courses. These data will also help the user to create trends and determine if interventions, such as instructor-led lessons or reading material that may impact performance.

These examples clearly demonstrate that the principles of this invention can be practiced to successfully solve and alleviate the problem of GPOP from various angles and perspectives. The invention being described in conjunction with the foregoing specific examples, many alternatives, variations and modifications will be apparent to those of ordinary skill in the art. These alternatives, variations and modifications are intended to fall within the spirit and scope of the present invention.

We claim:

1. A method for calculating pace of play of golf courses, comprising:
obtaining data from one or more golfers who are playing on a golf course, wherein the obtained data enables the calculation of the amount of time it takes the golfers to complete one or more holes within a golf course;
identifying the golf course that each golfer is playing;
calculating, for each identified golf course, the amount of time it takes the golfers to complete one or more holes within a golf course;
associating the calculated amount of time for each golfer with the identified golf course and speed factor data, wherein the speed factor data affects the pace of play;
receiving a user input selecting one or more golf courses or the location of one or more golf courses for play;
obtaining speed factor variables for each golf course selected by the user, wherein speed factor variables affect the pace of play;
predicting the pace of play for each golf course selected based on the amount of time it took one or more golfers to complete one or more holes within a golf course based on the available speed factor data, and the obtained speed factor variables; and
providing the predicted data to the user.

2. The method of claim 1 wherein predicting the pace of play for each golf course comprises making the predictions in real-time based on current speed factor variables.

3. The method of claim 1, wherein the data obtained from one or more golfers comprises GPS location and time data from each golfer.

4. The method of claim 1, wherein the data obtained from one or more golfers originates at each golfer's computing device.

5. The method of claim 1, wherein the data obtained from one or more golfers comprises data input by the golfers, wherein the input data identifying their location within a golf course, or the amount of time it takes the golfer to complete one or more holes within a golf course.

6. The method of claim 1, wherein the speed factor data comprises one or more of the following: the number of players on the golf course at the time of play, the handicap of the players on the golf course, the pace of play of each player on the golf course, the level of difficulty of the golf course, the weather conditions at the golf course at the time of play, the day of the week, the time of play, and the number of groupings of golfers.

7. The method of claim 1, wherein the user input comprises one or more golf courses for play or a geographic area for play.

8. The method of claim 1, wherein the user input further comprises a desired date and time for future play.

9. The method of claim 1, wherein the user input comprises an inquiry for current pace of play based on real-time data at one or more selected golf courses.

10. The method of claim 1, wherein the user input comprises the amount of time a user would like to play.

11. The method of claim 1, wherein the speed factor variables may be obtained from a variety of sources including one or more of the following: the golf course's database or directory, a weather service, a database of player's handicap index, and a database of pace of play associated with each player.

12. The method of claim 11, wherein the speed factor variables obtained from a golf course's database or directory comprises one or more of the following data: the number of players scheduled to play at a desired day and time of play, and the number of players that historically play at the desired day and time of play.

13. The method of claim 1, wherein the user's input originates at the user's computing device.

14. The method of claim 1, wherein the speed factor variables comprise one or more of the following:
the number of players on the golf course at a desired time of play, the handicap of the players on the golf course at a desired time of play, the pace of play of each player on the golf course who are scheduled to play at a desired time of play, the level of difficulty of the golf course, the weather conditions at the golf course at the desired time of play, the desired day and time of play, and the number of groupings of golfers.

15. The method of claim 1, further comprising:
ranking golf courses based on their predicted pace of play and the user input, wherein the user input identifying one or more of the following: the amount of time a user would like to play one or more holes within a golf course; the amount of money the user would like to spend on fees; the speed with which the user would like to play.

16. A system for calculating pace of play of golf courses, comprising:
a reception module for obtaining data from one or more golfers who are playing on a golf course, wherein the obtained data enables the calculation of the amount of time it took the golfers to complete one or more holes within a golf course;
a golf course identification module for identifying the golf course that each golfer is playing;
a time calculation module for calculating, for each identified golf course, the amount of time it took the golfers to complete one or more holes within a golf course;
an indexing module for associating the calculated amount of time for each golfer with the identified golf course and speed factor data, wherein the speed factor data affects the pace of play;
an input reception module for receiving a user input selecting one or more golf courses or the location of one or more golf courses for play;
a speed variable module for obtaining speed factor variables for each golf course selected by the user, wherein speed factor variables affect the pace of play;
a prediction module for predicting the pace of play for each golf course selected based on the amount of time it took one or more golfers to complete one or more holes within a golf course based on the available speed factor data, and the obtained speed factor variables; and
a communication module for providing the predicted data to the user.

17. The system of claim 16, wherein the prediction module is capable of predicting the pace of play for each golf course comprises making the predictions in real-time based on current speed factor variables.

18. The system of claim 16, wherein the reception module receives GPS location and time data from each golfer.

19. The system of claim 16, wherein the data obtained by the reception module originates from each golfer's computing device.

20. The system of claim 16, wherein the reception module obtains input by the golfers, wherein the input identifies the location of the golfers within a golf course, or the amount of time it took the golfer to complete one or more holes within a golf course.

21. The system of claim 16, wherein the indexing module associates obtained data with speed factor data, which comprises one or more of the following: the number of players on the golf course at the time of play, the handicap of the players on the golf course, the pace of play of each player on the golf course, the level of difficulty of the golf course, the weather conditions at the golf course at the time of play, the day of the week, the time of play, and the number of groupings of golfers.

22. The system of claim 16, wherein the input reception module receives one or more golf courses for play or a geographic area for play.

23. The system of claim 16, wherein the input reception module receives a desired date and time for future play.

24. The system of claim 16, wherein the input reception module receives an inquiry for current place of play based on real-time data at one or more selected golf courses.

25. The system of claim 16, wherein the input reception module receives input comprising the amount of time a user would like to play.

26. The system of claim 16, wherein the speed variables module obtains variable from a variety of sources including one or more of the following: the golf course's database or directory, a weather service, a database of player's handicaps, and a database of pace of play associated with each player.

27. The system of claim 26, wherein the speed variables module obtains one or more of the following data from a golf course's database or directory: the number of players scheduled to play at a desired day and time of play, and the number of players that historically play at the desired day and time of play.

28. The system of claim 16, wherein the input reception module receives input that originates at the user's computing device.

29. The system of claim 16, wherein the speed factor variables obtained by the speed variable module comprise one or more of the following: the number of players on the golf course at a desired time of play, the handicap of the players on the golf course at a desired time of play, the pace of play of each player on the golf course who are scheduled to play at a desired time of play, the level of difficulty of the golf course, the weather conditions at the golf course at the desired time of play, the desired day and time of play, and the number of groupings of golfers.

30. The system of claim 16, further comprising:
a ranking modules for ranking golf courses based on their predicted pace of play and the user input, wherein the user input identifying one or more of the following: the amount of time a user would like to play one or more holes within a golf course; the amount of money the user would like to spend on fees; the speed with which the user would like to play.
